(19) United States
(12) Patent Application Publication
(10) Pub. No.: US 2006/0148306 A1
(43) Pub. Date: Jul. 6, 2006

(54) High frequency application device

(76) Inventors: Kai Desinger, Berlin (DE); Thomas Stein, Berlin (DE); Andre Roggan, Berlin (DE)

Correspondence Address: BECK AND TYSVER P.L.L.C., 2900 THOMAS AVENUE SOUTH, SUITE 100, MINNEAPOLIS, MN, 55416, US

(21) Appl. No.: 10/517,393

(22) PCT Filed: May 30, 2003
(86) PCT No.: PCT/EP03/06460

§ 371 Date: Feb. 13, 2006

(30) Foreign Application Priority Data
May 29, 2002 (DE) 102 24 451.0

(51) Int. Cl. H01R 11/18

(52) U.S. Cl. 439/482

(57) ABSTRACT

Provided is a high frequency application apparatus comprising a high frequency generator 1, a probe arrangement 3 which is connected to the high frequency generator 1 and which includes at least two electrodes 8, 9, and at least two lines 11 which connect the electrodes 8, 9 to the high frequency generator 1, which is distinguished in that the lines 11 are combined together in a common cable (5). In that respect the term probes is used to denote not only probes which are suitable for introduction into the body such as for example catheters or electrode needles but also those which are to be fitted externally to the body.

This application claims priority to PCT/EP03/06460, filed May 30, 2003 and to DE 102 24 451.0-35, filed May 29, 2002.

### FIELD OF THE INVENTION

The invention concerns a high frequency application apparatus comprising a high frequency generator, a probe arrangement which is connected to the high frequency generator and which includes at least two electrodes, and at least two lines which connect the electrodes to the high frequency generator.

### BACKGROUND OF THE INVENTION

A method of treating pathologically altered body tissue, which is known in medicine, is electrosurgical and in particular electrothermal sclerosing of the tissue in question. That method is of particular interest for the therapy of organ tumors, for example liver tumors. To perform the sclerosing procedure one or more electrodes are placed in the tissue to be sclerosed, that is to say the tumor tissue, or in the immediate proximity thereof, and an alternating current is caused to flow between the electrodes or an electrode and a so-called neutral electrode which is fixed externally to the body. When the current flows between the electrode and the neutral electrode (possibly also between a plurality of electrodes and one or more neutral electrodes), that is referred to as a monopolar electrode arrangement. If in contrast the current flows between the electrodes themselves disposed in the tissue (in that case at least two electrodes have to be introduced into the tissue), that is referred to as a bipolar arrangement. The electrode provided for placement in the tissue is generally arranged on a needle suitable for puncturing the tissue, the so-called electrode needle. The bipolar arrangement can involve the use of a needle having at least two coaxially successively arranged electrodes. Alternatively however it is also possible to use a plurality of needles each having at least one respective electrode.

To cause sclerosing of the body tissue, in particular pathologically altered tissue, a current flow is induced by means of a high frequency generator between the so-called active electrodes which are in electrically conductive contact with the body tissue, and for example a neutral electrode. In that situation the electrical resistance of the body tissue provides that the alternating current is converted into heat. At temperatures of between 50° C. and 100° C. that involves massive denaturing of the body-specific proteins and consequently causes the tissue area involved to die. By virtue of the high current density in the region of the active electrodes heating of the tissue takes place predominantly where the active electrodes are in electrically conductive contact with the body tissue.

In the interests of effective treatment it is advantageous to check the progress of the treatment in as near real-time relationship as possible. For that purpose it is desirable to monitor the progress of the tumor treatments during the treatment by means of nuclear magnetic resonance tomography. Nuclear magnetic resonance tomography is particularly suitable for producing images of tumors in body tissue and for producing images of the coagulation condition of the tissue. In order to prevent the nuclear magnetic resonance tomographs from being disturbed by electromagnetic interference fields, they are operated in especially shielded rooms. More specifically electromagnetic interference fields would cause serious disturbance to the imaging procedure and thus give rise to artefacts in the imaging procedure. In extreme situations imaging would become impossible as a result of that.

The high frequency generators for producing the alternating current used in the electrosurgical treatment therefore have to be operated outside the shielded rooms, by virtue of the electrical and magnetic interference fields emanating from them, and that can result in great distances and long lines between the high frequency generator and the electrodes of the body probes, for example the electrode needles.

### SUMMARY OF THE INVENTION

Therefore the object of the invention is to provide a high frequency application apparatus which is particularly suitable for operation together with a nuclear magnetic resonance tomograph, in particular even when the nuclear magnetic resonance tomograph makes it necessary to provide a great distance between the high frequency generator and the probe arrangement.

That object is attained by a high frequency application apparatus comprising a high frequency generator, a probe arrangement which is connected to the high frequency generator and which includes at least two electrodes, and at least two lines which connect the electrodes to the high frequency generator, which is distinguished in that the lines are combined together in a common cable. In this respect the term probes is to be taken to mean not only probes which are suitable for being introduced into the body such as for example catheters or electrode needles, but also those which are to be applied externally to the body, such as for example neutral electrodes.

The invention is based on the following considerations:

The longer the cable between the high frequency generator and the probe arrangement, the correspondingly greater is the power loss in the cable. In order to compensate for the power loss in long cables, the high frequency generators of high frequency application apparatuses in accordance with the state of the art are designed in such a way that they deliver a higher level of power than would actually be necessary for the treatment.

Now the invention does not follow the path of compensating for the power loss by increasing the power of the generator, but is aimed at reducing the power loss in the lines themselves. At the same time interference effects emanating from the lines in the imaging procedure in the nuclear magnetic resonance tomograph can also be alleviated. By virtue of the reduced power loss, the power which the high frequency generator has to deliver in addition to the power required for the treatment in order to compensate for the power loss in the lines can be reduced.

In accordance with the invention that is achieved by the structure of the cable and in particular by the arrangement of the lines relative to each other. As therefore, unlike the situation in the state of the art, the connection between the active electrodes and the high frequency generator and the connection between the discharging (passive) electrodes or neutral electrodes and the high frequency generator are combined together in a cable, this means that the cable has at least two lines.

The advantage of this arrangement is that for example parasitic inductances which in the state of the art can result from the frequently careless and therefore tortuous manner of laying the long lines between the generator and the patient can be compensated by the opposite flow paths on the outgoing and return lines of the cable of the high frequency application apparatus according to the invention.

Combining the lines together reduces the inductive resistance of the lines as well as the power which is emitted from the cable when the alternating current flows therethrough and thus the power loss and the power attenuation effect in the cables in comparison with lines which are not combined together.

In the high frequency application apparatus according to the invention the high frequency generator can be set up in operation further away from the probe arrangement than in the case of a high frequency application apparatus in accordance with the state of the art, without its power output having to be increased for that purpose in comparison with the generator in the high frequency application apparatus in accordance with the state of the art.

On the other hand, as the power loss in the cable is less than in a high frequency application apparatus in accordance with the state of the art with a cable of equal length, the power output of the generator can be reduced in comparison with the generator in the high frequency application apparatus in accordance with the state of the art.

The advantages of the high frequency application apparatus according to the invention provide in particular that, even in relation to treatments which are carried out together with nuclear magnetic resonance tomographs which are disposed in a large shielded room, the high frequency generator can be set up outside the shielded room.

The above-indicated advantages can be achieved to a particularly high degree if the lines in the cable extend in mutually parallel relationship at a defined spacing at least over a part of the length of the cable which preferably measures more than half the total length of the cable. That defined spacing preferably corresponds to between 2 and 20 times the diameter of the lines. Suitable spacings are between 1 mm and 25 mm. The part of the length of the cable, over which the lines thereof extend in mutually parallel relationship, preferably measures at least 4 meters.

Besides the ohmic and the inductive resistance, the value of the cable capacitance is also of significance. The cable capacitance is correspondingly greater and thus the capacitive resistance of the cable is correspondingly smaller, the closer together that the two lines extend in the cable. If the capacitance is too high, then in some high frequency generators the impedance measurement which is necessary to detect detachment of the neutral electrodes or to detect termination of the therapy (for example when the tissue impedance has reached a given predetermined rise) fails; because of the high cable capacitance and the low capacitive resistance linked thereto, it affords an excessively low impedance value as the alternating current in the impedance measurement finds a current path from one line in the cable to the other, which current path is linked to a relatively low capacitive resistance. In order to permit undisturbed impedance measurement it is therefore advantageous for the lines in the cable to be disposed at a defined spacing relative to each other. By virtue of a suitable choice in respect of the defined spacing, the cable capacitance can be set to a value with which the above-indicated problems can be avoided. The spacing between the lines which is appropriate depends on the cross-section of the lines. The greater the respective line cross-section, the correspondingly greater should the spacing between the lines be. A spacing of between 0.5 and 25 mm, preferably between 1 and 10 mm, is found to be a suitable spacing for the lines which are usually employed for high frequency application apparatuses.

Advantageously, the lines at the end of the cable towards the generator extend separately from each other in order to permit the connection thereof to such high frequency generators as are usually employed in high frequency application apparatuses in accordance with the state of the art. Those normal high frequency generators typically have two separate, different connections for the lines.

In the case of the monopolar use, the lines can also be divided at the probe end of the cable in order to permit separate connection of the electrode needle and the neutral electrode.

In order to reduce the ohmic resistance a line can respectively include a plurality of wires. The more wires that a line includes, the correspondingly greater is the cross-section of the line, that is effective for the flow of current, so that its ohmic resistance falls. The design configuration with a plurality of wires for each line however reduces not only the ohmic resistance of the line but also makes it possible to provide wires for implementing measurement procedures, for example measuring the impedance of the current path between two electrodes or temperature measurement procedures.

In an embodiment of the high frequency application apparatus according to the invention the lines and/or the wires are stranded with each other, that is to say, twisted together. The twisted configuration further reduces the power emanating from the cable and thus also the power attenuation effect. In addition twisting reduces the sensitivity of the line to interference.

In an alternative configuration of the high frequency application apparatus the lines extend in mutually coaxial relationship.

In an embodiment the probe arrangement includes an electrode needle. To use the probe in the bipolar mode the electrode needle has at least two active electrodes of which each is connected to a line or a wire of the cable. In an alternative configuration intended for use of the probe in the monopolar mode the probe arrangement includes an electrode needle and an electrode which is to be fitted externally to the body. In that case the electrode needle has at least one active electrode, the active electrode and the neutral electrode each being connected to a respective line or wire of the cable.

Besides the improvement in the line properties (ohmic, capacitive and inductive resistance), the situation with nuclear magnetic resonance tomography involves suppressing the conduction of interference signals through the lines. That is important because the high frequency generator is disposed outside the measurement room and thus is operated in an environment in which interference is not suppressed. Such interference can in principle be caught by the connecting cable (antenna) and passed into the measurement room. Such electromagnetic interference fields which are collected by the cable can seriously disturb the imaging procedure in the nuclear magnetic resonance tomograph.

In a further configuration of the high frequency application apparatus according to the invention therefore the cable can be surrounded outside the room in which the nuclear magnetic resonance tomograph is disposed by a ferromagnetic ring, in particular a ferrite core, as a high frequency choke. In that respect the term ring is to be interpreted as meaning not just objects of a geometrically ring shape but also all those which are of an oval, angular or irregular shape and have an opening for a cable to pass therethrough.

Interference effects can be filtered out with the high frequency choke without the capacitance of the cable being increased.

In a further configuration of the invention electromagnetic interference fields are shielded by an electrically conducting casing or shield which surrounds the cable. The casing or shield extends at least from the generator to the location on the cable at which it is introduced into the shielded room of the nuclear magnetic resonance tomograph. Advantageously the casing or shield is of such a configuration that it can be electrically connected to the shielding arrangement of the nuclear magnetic resonance tomograph, which is formed by a Faraday cage.

An alternative possible way of suppressing interference signals, which is advantageous independently of combining the lines together in a cable and the ferromagnetic ring, involves the provision of a switching device with which a portion of the cable or the lines, which is at the generator end, can be separated from a portion of the cable or the lines, which is at the probe end, and connected thereto again. Actuation of the switching device causes the generator-end portion to be separated from the probe-end portion so that no interference is transmitted by way of the cable into the room of the nuclear magnetic resonance tomograph. That is particularly advantageous if highly sensitive measurements which would already be considerably disturbed by the smallest interference signals are to be conducted with the nuclear magnetic resonance tomograph.

The switching device may include one or more relays, in particular reed relays. Alternatively, the switching device can also be of a configuration comprising at least one mechanical switch, for example a pneumatic switch.

The switching device is advantageously of such a configuration that it is closed in the normal condition, that is to say there is a conducting connection between the generator-end portion of the cable and the probe-end portion.

To trigger the switching device, it may include a signal line, at the end of which is arranged an actuating switch with which the switching device is to be switched from the room in which the high frequency generator is disposed.

Alternatively there is also the possibility of the switching device being provided with an interface to which a control line of the nuclear magnetic resonance tomograph can be connected so that the nuclear magnetic resonance tomograph can automatically separate the generator-end portion of the cable from the probe-end portion thereof, for example when a high-sensitive measurement operation is to be effected.

In a further advantageous configuration the cable and the probe arrangement can be adapted to be re-sterilizable so that the high frequency application apparatus is suitable for treating a patient in a sterile environment.

### BRIEF DESCRIPTION OF THE DRAWINGS

Further features and advantages of the invention are described hereinafter by means of embodiments by way of example with reference to the accompanying drawings in which:

FIG. 1 shows a first embodiment by way of example of the high frequency application apparatus according to the invention,

FIG. 2 shows a first embodiment of the cable between the high frequency generator and the probe arrangement,

FIG. 3 shows a second embodiment of the cable between the high frequency generator and the probe arrangement,

FIG. 4 shows a third embodiment of the cable between the high frequency generator and the probe arrangement,

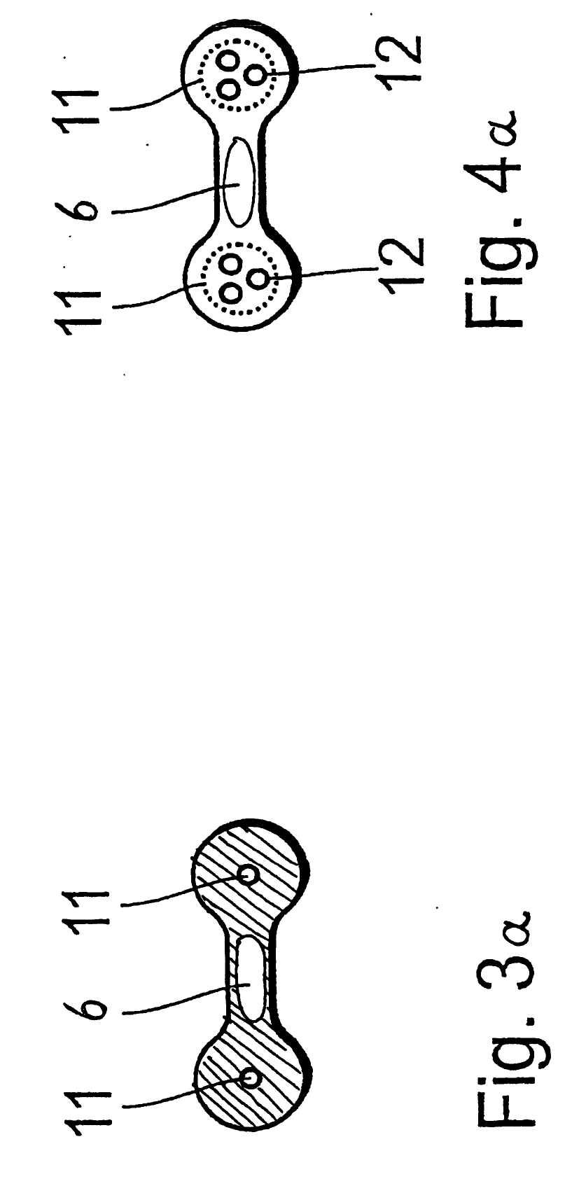

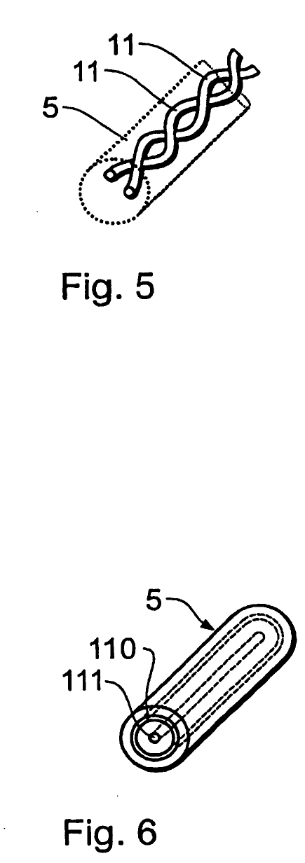

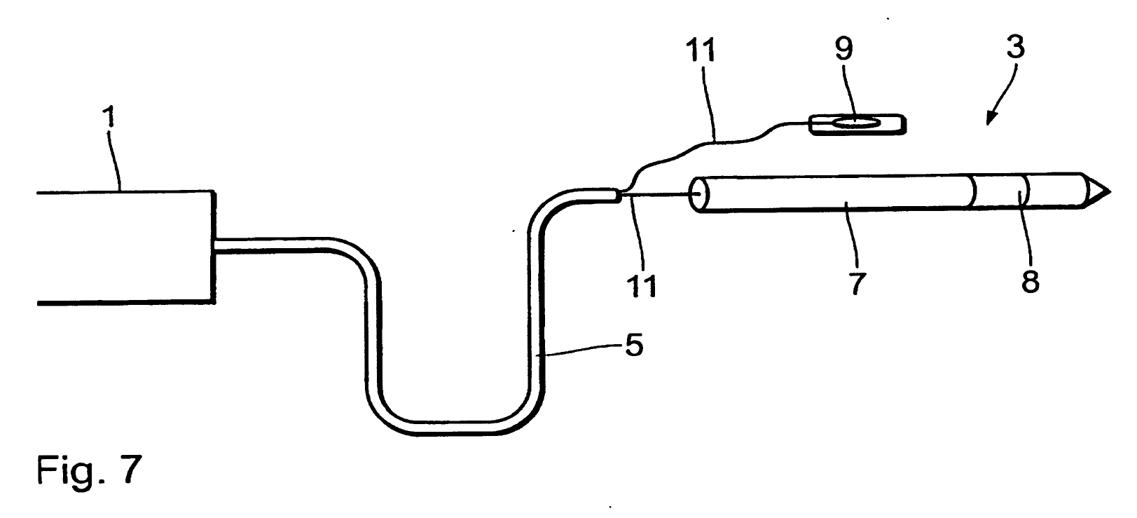

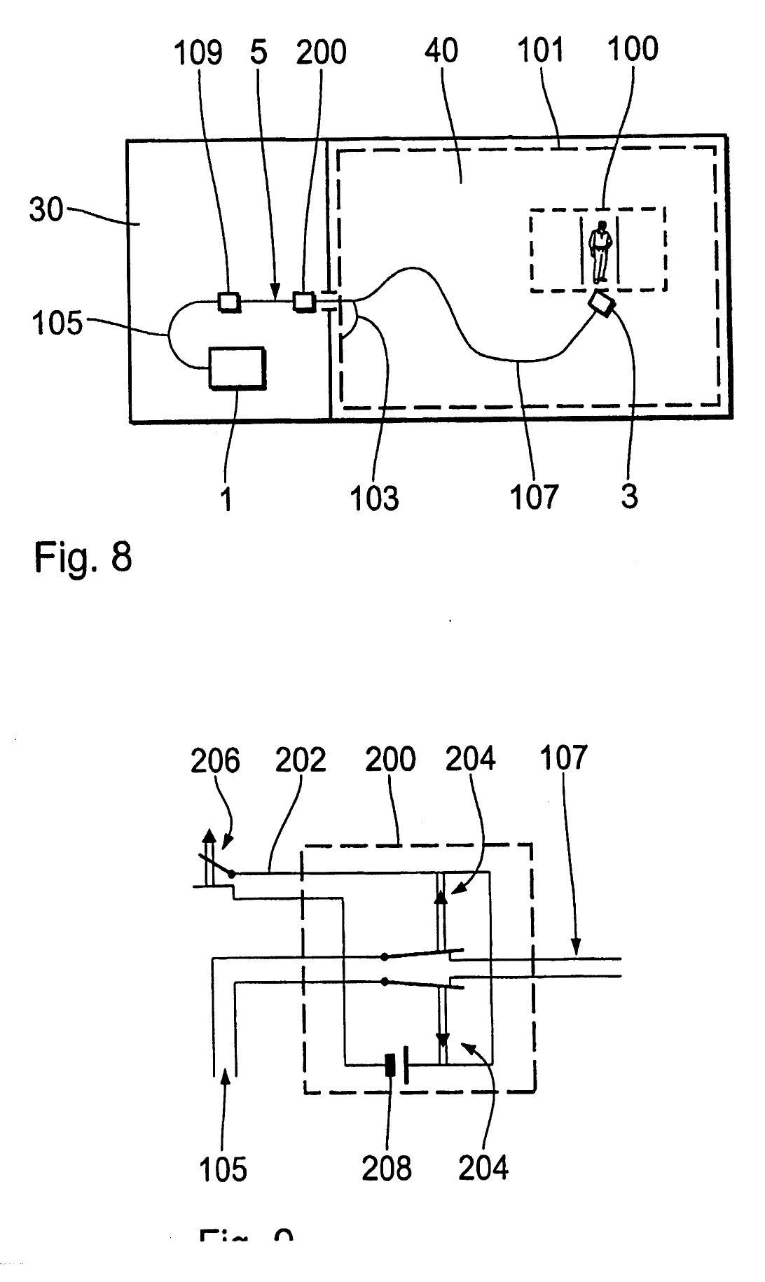

FIGS. 3a and 4a show alternatives to the embodiments of the cable shown in FIGS. 3 and 4 with an additional air cushion between the lines,

FIG. 5 shows a fourth embodiment of the cable between the high frequency generator and the probe arrangement,

FIG. 6 shows a fifth embodiment of the cable between the high frequency generator and the probe arrangement,

FIG. 7 shows a second embodiment by way of example of the high frequency application apparatus according to the invention,

FIG. 8 shows the setup of the high frequency application apparatus according to the invention in use, and

FIG. 9 shows a switching device arranged on the cable of the high frequency application apparatus.

### DETAILED DESCRIPTION OF THE PREFERRED EMBODIMENT(S)

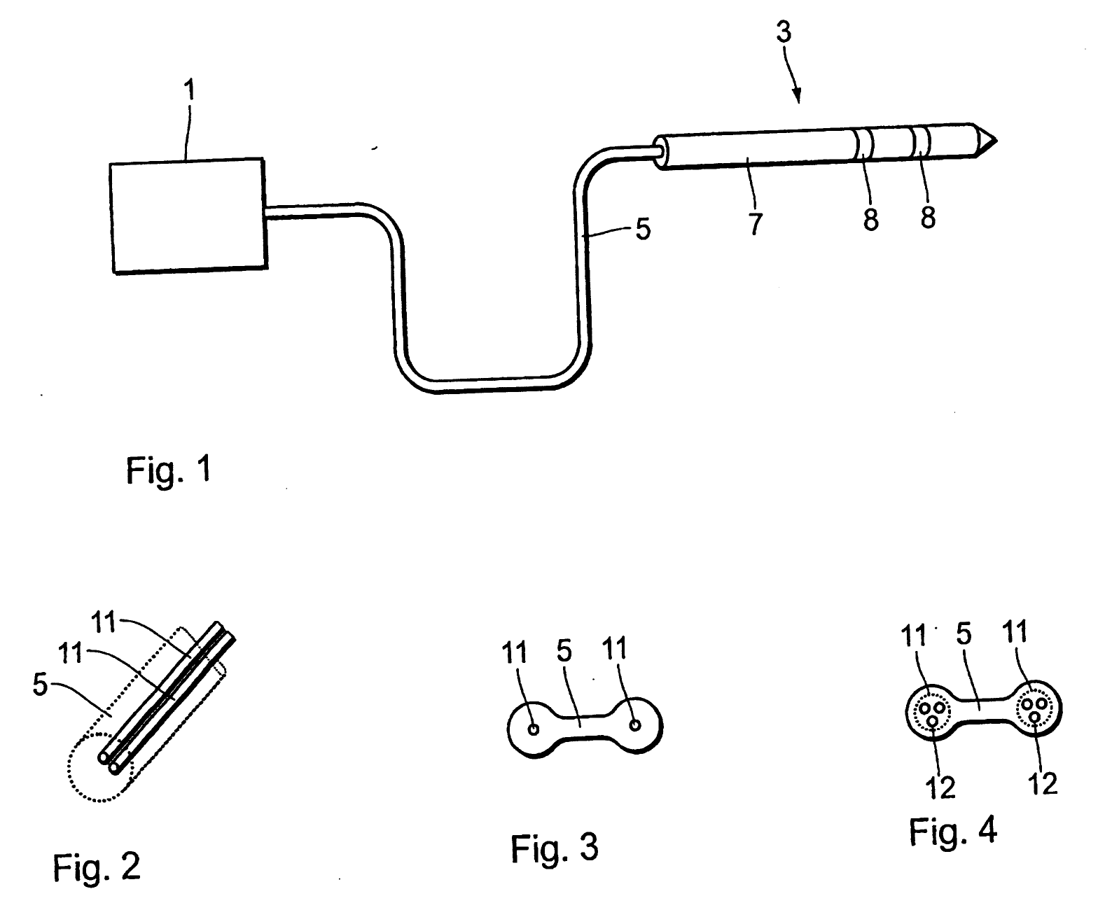

FIG. 1 shows a first embodiment by way of example of the high frequency application apparatus according to the invention. The high frequency application apparatus includes a high frequency generator 1, a probe arrangement 3 and a cable 5 connecting the high frequency generator 1 to the probe arrangement 3.

The probe arrangement 3 of the first embodiment includes an electrode needle 7 designed for bipolar use, having a portion which is provided for introduction into the body tissue and at the distal end of which there are two active electrodes 8. It will be appreciated that there can also be more than two active electrodes 8. Besides the portion for introduction into the body the electrode needle 7 also has a gripping portion for handling the needle (not explicitly illustrated in the Figures).

Various embodiments of the cable 5 of the high frequency application apparatus are illustrated in detail in FIGS. 2 through 6.

Extending in the interior of the cables 5 shown in FIGS. 2 and 3 are two axis-parallel lines 11 which are arranged at a defined spacing relative to each other. The spacing is so small that the desired reduction in the power losses and the interference phenomena is achieved, but it is at least so great that the capacitive coupling of the two lines does not interfere with operation of the high frequency application apparatus. Suitable spacings for the two lines 11 from each other are in the range of between 0.5 and 25 mm, wherein the spacings between 1 and 10 mm are found to be particularly appropriate.

In the embodiment of the cable 5 shown in FIG. 4 the lines 11 include a plurality of wires 12 in order for example to reduce the ohmic resistance of the lines 11 or to make measuring wires available.

The cables shown in FIGS. 3a and 4a correspond to the cables shown in FIGS. 3 and 4, except for a respective air cushion 6 arranged between the lines 11. The air cushion 6 makes it possible to optimize the dielectric constant εᵣ between the lines 12, in such a way that the capacitance of the cable 5 per unit of length falls.

A further variant of the cable 5 is shown in FIG. 5. That cable also includes two lines 11 which however are stranded (twisted) together. If a line 11 includes a plurality of wires 12 the wires 12 of a line 11 can also be twisted together.

FIG. 6 shows a variant of the cable 5 in which the lines 110 and 111 extend at a defined spacing in mutually coaxial relationship, the one line 110 surrounding the other line 111. In regard to the spacing between the two lines 11, the same considerations apply as for the cable with axis-parallel lines.

The cable 5 can also include a shielding means for shielding interference radiation, which can be connected in particular to the shielding means (101 in FIG. 8) of the nuclear magnetic resonance tomograph 100 for electromagnetic interference radiation (for example by means of a connecting line 103) in order to set both shielding means at the same potential. It is also possible for each line of the cable to be provided with its own shielding means.

The cables 5 shown in FIGS. 2 through 6 can include any material which is usual in cable manufacture, as the material in which the lines 11, 110, 111 and/or the wires 12 are embedded. Because of their sterilizability or their in part relatively low dielectric constant suitable materials are in particular polyethylene (PE), Teflon—for example polytetrafluoroethylene (PTFE) or polyfluoroethylene-propylene (FEP)-, silicone, neoprene (styrene butadiene rubber, SBR) and polyvinylchloride (PVC). Such materials make it possible for the entire cable 5 to be made in such a way that it is re-sterilizable and thus permit the high frequency application apparatus to be operated in a sterile environment.

In the first embodiment the lines 11 or wires 12 of the cable 5 are connected to a respective active electrode 8 of the electrode needle 7. In operation a high frequency voltage is fed to the active electrodes 8 by the lines 11, and that voltage provides that a high frequency current flows through the body tissue between the electrodes 8 and results in sclerosing of the body tissue.

A second embodiment by way of example of the high frequency application apparatus according to the invention is shown in FIG. 7. This embodiment only differs from the embodiment illustrated in FIG. 1 in that the probe arrangement 3 is adapted for monopolar use, instead of bipolar use. For that purpose the probe arrangement 3 includes a needle electrode 7 having an active electrode 8 for introduction into the body tissue and a neutral electrode 9 for application to the surface of the body. Both the active electrode 8 and also the neutral electrode 9 are respectively connected to a line 11 or a wire of the cable 5. In this case the lines 11 and wires 12 are combined together at a defined spacing over the greatest possible length.

Admittedly in the embodiment illustrated in FIG. 7 the lines 11 of the cable 5 already separate prior to the electrode needle, but it is also possible for both lines to be introduced into the electrode needle, in particular into the gripping portion thereof, and for them to be separated only at that location. In that case the electrode needle and in particular the gripping portion thereof has a connection by way of which the neutral electrode can be connected to the electrode needle 7 by means of a line 11 so that it can be supplied with current by the electrode needle 7.

In use of the high frequency application apparatus a high frequency voltage is fed to the electrodes 8, 9 by the lines 11 so that a high frequency current flows between the active electrode 8 and the neutral electrode 9 through the body tissue, and results in sclerosing of the tumor tissue.

A setup for use of the high frequency application apparatus according to the invention is illustrated in FIG. 8. FIG. 8 shows a nuclear magnetic resonance tomograph 100 disposed in a treatment room 40 provided with a Faraday cage 101 as a shielding means against electromagnetic interference radiation. Also disposed in the treatment room 40 are the major part of the probe-end portion 107 of the cable 5 and the probe arrangement 3 of the high frequency application apparatus. The other components of the high frequency application apparatus, in particular the high frequency generator 1 and the generator-end portion 105 of the cable 5 in contrast are disposed in an operational room 30 which is adjacent to the treatment room 40.

If the cable 5 is provided with a shielding means against electromagnetic interference radiation, the shielding means has a connecting cable 103 with which it is connected to the Faraday cage 101 of the treatment room 40 in order to put both the Faraday cage 101 and also the shielding means at a common potential. The shielding means of the cable 5 extends at least from the generator 1 to the passage ducting means through which the cable 5 passes into the treatment room 40. Typically however the shielding means will extend over the entire cable 5 as that is easier to manufacture.

In addition at least one high frequency choke, for example a ferrite core 109, can be arranged on the cable 5, for the suppression of interference signals on the lines 11.

In addition, a switching device 200 can be arranged between the generator-end portion 105 and the probe-end portion 107 of the cable 5, with which switching device the two portions can be electrically separated from each other. It can be arranged either in the treatment room 40 or in the operational room 30 but preferably it should be disposed in the proximity of the passage ducting means, which connects the two rooms together, for passing the cable therethrough.

The switching device 200 is shown in detail in FIG. 9. The Figure shows the generator-end portion 105 and the probe-end portion 107 of the cable 5. Disposed between the respective lines of the two portions are switches 204 with which the lines of the two portions can be separated from each other or connected to each other.

Actuation of the switch 204 is effected by way of an actuating switch 206 which is connected by way of signal line 202 to a circuit including a battery 208, the actuation of the actuating switch triggering opening of the switch 204.

Optionally all lines or line portions illustrated in FIG. 9 can be provided with ferromagnetic rings, in particular ferrite cores, for the suppression of interference signals.

Relays, in particular reed relays, can be used as the switches 204. Alternatively however it is also possible to use mechanical switches, for example pneumatic switches.

As shown in FIG. 9 the signal line 202 can go to an actuating switch 206, by means of which the operating personnel in the operational room 30 can interrupt the feed of the high frequency current to the probe arrangement 3 if measurements which have a highly sensitive reaction to interference radiation are to be effected with the nuclear magnetic resonance tomograph 100.

Alternatively the connecting cable 202 can also be suitable for connection to an interface of the nuclear magnetic resonance tomograph 100 so that the latter can automatically interrupt the feed of high frequency current to the probe device 3 if a particularly sensitive measurement procedure is impending.

1. A high frequency application apparatus comprising a high frequency generator, a probe arrangement which is connected to the high frequency generator and which includes at least two electrodes, and at least two lines which connect the electrodes (8, 9) to the high frequency generator,
characterized in that
the lines are combined together in a common cable and extend in mutually parallel relationship at least over a part of the length of the cable at a defined spacing which is between 1 mm and 25 mm.

2. A high frequency application apparatus set forth in claim 1 characterized by an air cushion which within the part of the length of the cable in which the lines extend parallel is arranged between the lines within the cable.

3. A high frequency application apparatus as set forth in claim 1 characterized in that the lines extend separately at the end of the cable towards the generator.

4. A high frequency application apparatus as set forth in claim 1 characterized in that a line includes a plurality of wires.

5. A high frequency application apparatus as set forth in claim 1 characterized in that the lines and/or the wires are twisted together.

6. A high frequency application apparatus as set forth in claim 1 characterized in that the lines extend in mutually coaxial relationship.

7. A high frequency application apparatus as set forth in claim 1 characterized in that the probe arrangement includes an electrode needle.

8. A high frequency application apparatus as set forth in claim 6 characterized in that the electrode needle includes at least two active electrodes.

9. A high frequency application apparatus as set forth in claim 1 characterized in that the probe arrangement includes an electrode needle and a neutral electrode to be applied externally to the body.

10. A high frequency application apparatus as set forth in claim 9 characterized in that the electrode needle includes at least one active electrode (8).

11. A high frequency application apparatus as set forth in claim 1 characterized in that a ferromagnetic ring is mounted on the cable.

12. A high frequency application apparatus as set forth in claim 1 characterized in that the cable is provided with an electrically conductive shield or casing.

13. A high frequency application apparatus as set forth in claim 12 characterized in that the shield or the casing includes a connection by way of which it is to be electrically connected to a shielding means of a nuclear magnetic resonance tomograph.

14. A high frequency application apparatus comprising a high frequency generator, a probe arrangement which is connected to the high frequency generator and which includes at least two electrodes, and at least two lines which connect the electrodes to the high frequency generator,
characterized in that
the lines have a portion towards the generator and a portion towards the probe, between which is a switching device for separating and connecting the generator-end portion and the probe-end portion.

15. A high frequency application apparatus as set forth in claim 1 wherein the lines have a portion towards the generator and a portion towards the probe, between which is a switching device for separating and connecting the generator-end portion and the probe-end portion.

16. A high frequency application apparatus as set forth in claim 14 characterized in that the switching device includes an electrical switch.

17. A high frequency application apparatus as set forth in claim 16 characterized in that the electrical switch is a reed relay.

18. A high frequency application apparatus as set forth in claim 14 characterized in that the switching device includes a mechanical switch.

19. A high frequency application apparatus as set forth in claim 14 characterized in that the switching device includes a signal line and an actuating switch which are of such an arrangement and configuration that separation and connection can take place in the room in which the high frequency generator is disposed.

20. A high frequency application apparatus as set forth in claim 14 characterized in that the switching device includes an interface for the connection of a control line to a nuclear magnetic resonance tomograph.

21. A high frequency application apparatus as set forth in claim 1 characterized in that the probe arrangement and the cable are adapted to be re-sterilizable.

22. A high frequency application apparatus as set forth in claim 14 wherein the lines have a portion towards the generator and a portion towards the probe, between which is a switching device for separating and connecting the generator-end portion and the probe-end portion.

23. A high frequency application apparatus as set forth in claim 15 characterized in that the switching device includes an electrical switch.

24. A high frequency application apparatus as set forth in claim 22 characterized in that the switching device includes an electrical switch.

25. A high frequency application apparatus as set forth in claim 23 characterized in that the electrical switch is a reed relay.

26. A high frequency application apparatus as set forth in claim 24 characterized in that the electrical switch is a reed relay.

27. A high frequency application apparatus as set forth in claim 15 characterized in that the switching device includes a mechanical switch.

28. A high frequency application apparatus as set forth in claim 15 characterized in that the switching device includes a signal line and an actuating switch which are of such an arrangement and configuration that separation and connection can take place in the room in which the high frequency generator is disposed.

29. A high frequency application apparatus as set forth in claim 15 characterized in that the switching device includes an interface for the connection of a control line to a nuclear magnetic resonance tomograph.

30. A high frequency application apparatus as set forth in claim 14 characterized in that the probe arrangement and the cable are adapted to be re-sterilizable.
